(19) United States
(12) Patent Application Publication
(10) Pub. No.: US 2007/0222257 A1
(43) Pub. Date: Sep. 27, 2007

(54) Core module for door assembly having integrated reinforcements

(76) Inventors: Joseph Gustaaf Marie Flendrig, Brussels (BE); Jeffrey Valentage, Royal Oak, MI (US)

Correspondence Address: ExxonMobil Chemical Company;Law Technology, P.O. Box 2149, Baytown, TX, 77522-2149, US

(21) Appl. No.: 11/704,128

(22) Filed: Feb. 8, 2007

Related U.S. Application Data
(63) Continuation-in-part of application No. 11/590,307, filed on Oct. 31, 2006.
(60) Provisional application No. 60/802,146, filed on May 19, 2006.
(60) Provisional application No. 60/785,043, filed on Mar. 23, 2006.
(60) Provisional application No. 60/785,039, filed on Mar. 23, 2006.

(51) Int. Cl. B60J 5/00

(52) U.S. Cl. 296/146.6

(57) ABSTRACT

A core module is provided. The core module includes a body, a first reinforcement member disposed at an upper portion of the body, a second reinforcement member disposed on a perimeter of the body, and a lock mechanism attached to the second reinforcement member.

### CROSS REFERENCE TO RELATED APPLICATIONS

This application claims the benefit of and priority from USSN 60/802,146, filed May 19, 2006, USSN 60/785,043 filed, Mar. 23, 2006, and USSN 60/785,039, filed Mar. 23, 2006. This application is also a continuation-in-part of 11/590,307, filed Oct. 31, 2006. All of the above applications are fully incorporated herein by reference.

### BACKGROUND OF THE INVENTION

1. Field of the Invention

This invention relates to door systems. More particularly, embodiments of the present invention relate to door systems for vehicles, such as automobiles, specifically cars and trucks.

2. Description of the Related Art

Conventional doors for automobiles contain many individual pieces that are assembled to a frame or shell. Automotive doors can have more than fifty to greater than one hundred individual components or parts depending on the vehicle and option package. Such components can include various hardware, electrical components, and seals. Illustrative hardware components can include handles, mirrors, window regulators, window tracks, windows, door locks, and impact bolsters. Certain electrical components can include wire harnesses, speakers, window motors, and outside mirror motors. Illustrative sealing components include glass run channels, beltline seals, lower sash seals, plugs, grommets, and body to door seals.

Each component is typically supplied by a different vendor or supplier, some of which are known in the industry as Tier 1, Tier 2, and Tier 3 suppliers. In most cases, an original equipment manufacturer (OEM) produces a door frame and exterior skin that are typically stamped separately from cold rolled steel, welded together, and painted to provide a door shell. The frame and skin can possibly be stamped from one blank to form the door shell. The numerous individual components from the Tier 1, 2, and 3 suppliers are then assembled onto the OEM's door shell, typically at the OEM's assembly line.

The process of affixing the components to the door shell is intensive and requires costly logistical considerations and/or systems to assure the right parts are at the right place at the right time. The assembly process can also demand a large amount of costly floor space. Each component is attached to the door shell using at least one of many different means including clips, screws, fittings, adhesives, just to name a few. In most cases, twenty to forty five different assembly steps are needed to complete the entire assembly process of the door.

FIG. 1 shows a schematic illustration of a conventional door 100. Typically, the door 100 has an interior trim panel 110, inner panel 120, intrusion beam 130, reinforcement section 140, and outer panel 150. Typically, the inner panel 120, intrusion beam 130, reinforcement section 140, and outer panel 150 are each formed from steel, stamped, welded together, and painted at the OEM. The numerous hardware, electrical and sealing components such as those listed above (not shown in FIG. 1 for simplicity) are typically assembled onto the steel inner panel 120 at the OEM. Similarly, the various components on the interior trim panel 110, including lights, switches, armrests, map pockets, handles, etc., (also not shown for simplicity) are assembled at a Tier supplier and shipped to the OEM. The OEM attaches the assembled trim panel 110 to the assembled inner panel 120, and the final electrical and hardware connections are made.

The assembly process also requires a high degree of logistical planning to ensure all the parts are available and assembled in the correct manner and order. Other incidental and related costs include ordering, storage, management, transportation, functionality testing, quality control, in addition to the floor space to assemble the various components. All those factors add up to a time consuming and costly end product.

Cost savings and part consolidation ideas have tried using pre-assembled mounting panels with all or part of the hardware and electrical components assembled thereon as shown in FIG. 2. FIG. 2 shows a schematic illustration of a conventional door 200 having a pre-assembled mounting panel 210. Numerous components are assembled to the mounting panel 210, including an interior door handle 215, handle linking cables 220, window motor 225, window regulator 230, speaker 235, window guide rail 240, drum pulley 245, cable 250, and door lock unit 260.

All or part of the hardware and electrical components can be installed onto the mounting panel 210 at an outside supplier, such as a Tier 1 supplier. The mounting panel 210 is typically made from stamped steel, thermoformed glass mat reinforced thermoplastic (GMT), or injection molded long glass fiber reinforced polypropylene. Once the applicable components are assembled onto the mounting panel 210 at the outside supplier, the assembled mounting panel 210 is transported to the OEM for installation on a door panel sub-assembly or outer panel 270. An interior trim panel 280 is then attached to the outer panel 270. Other part consolidation ideas are described in U.S. Pat. Nos. 6,857,688; 6,640,500; 6,546,674; 6,449,907; 5,820,191; 5,355,629; 5,040,335; 4,882,842; 4,648,208; and WO 01/25055 A1.

Several examples of pre-assembled mounting panels are believed to be in production. However, the number of components and the required assembly time of the door is substantially the same. The cost benefits to the OEM are mainly due to logistical costs absorbed by the Tier suppliers.

There is a need, therefore, for a door assembly having fewer individual components. There is also a need for a door assembly that minimizes the number of individual components requiring assembly. There is a further need for a door design that simplifies the assembly process.

### SUMMARY OF THE INVENTION

A door core module is provided. In at least one embodiment, the door core module includes a body, a first reinforcement member disposed at an upper portion of the body, a second reinforcement member disposed on a perimeter of the body, and a lock mechanism attached to the second reinforcement member.

A door system is also provided. In at least one embodiment, the door system includes an outer panel having a notch formed in an outer wall thereof, a core module, and a trim panel adapted to at least partially cover the core module. In one or more embodiments, the core module includes a body, a first reinforcement member disposed at an upper portion of the body, a second reinforcement member disposed on a perimeter of the body, and a lock mechanism attached to the second reinforcement member. The second reinforcement member is adapted to at least partially cover the notch formed in the outer panel.

A method for assembling a door system is also provided. In at least one embodiment, the method includes providing at least one outer panel, at least one core module, and at least one trim panel. The at least one outer panel has a notch formed in an outer wall thereof. A first reinforcement member is disposed on an upper portion of the core module. A second reinforcement member is disposed on a perimeter of the core module. A lock mechanism is disposed on the second reinforcement member. A first glass run channel is disposed on an exterior side of the core module, and a second glass run channel is disposed on the outer panel. A window glass is disposed on the core module, and the core module is disposed on the outer panel. The trim panel is then attached.

### BRIEF DESCRIPTION OF THE DRAWINGS

FIG. 1 is a schematic illustration of a conventional door as used in the prior art.

FIG. 2 is a schematic illustration of a conventional door having a pre-assembled mounting panel as used in the prior art.

FIG. 3 is a schematic view of one illustrative embodiment of an integrated door system.

FIG. 4 is a schematic view of one illustrative embodiment of a door structure.

FIG. 5 is a schematic plan view of an illustrative trim panel in accordance with one or more embodiments described.

FIGS. 6-8 show a simplified, schematic of an assembly sequence in accordance with one or more embodiments described.

FIG. 9 is a schematic view of an illustrative reinforcement member in accordance with one or more embodiments described.

FIG. 10A is a schematic plan view of the reinforcement member shown in FIG. 9 having a cover plate attached thereto.

FIG. 10B is a cross sectional view of an illustrative reinforcement member having one or more clips to secure a cover plate thereon.

FIG. 10C is a cross sectional view of an illustrative reinforcement member having a profiled edge or protrusion formed thereon.

FIG. 11A is a schematic view of an illustrative reinforcement member having one or more stiffening structures disposed thereon.

FIG. 11B and FIG. 11C show various design patterns of the one or more stiffening structures shown in FIG. 11A.

FIGS. 12A, 12B, and 12C each show schematic plan views of an illustrative reinforcement member having an insert disposed therein.

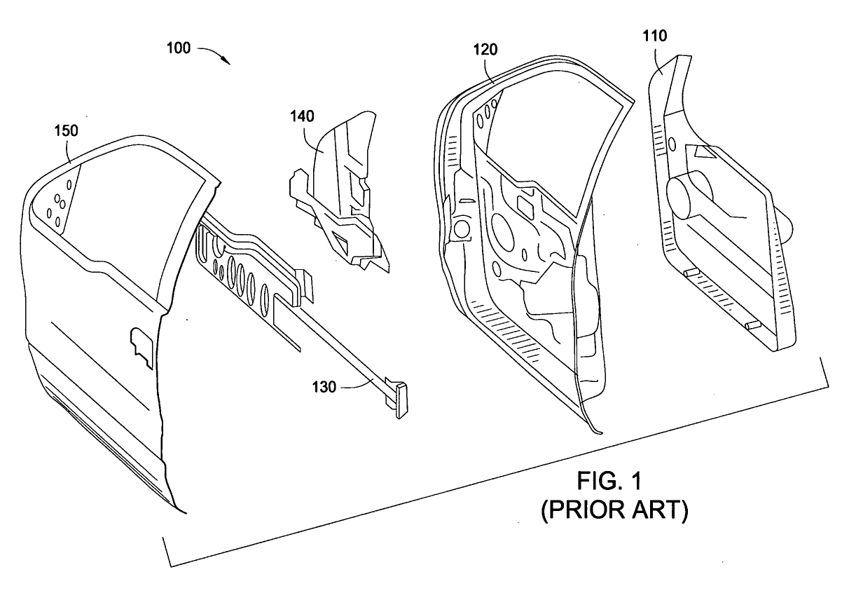

### DETAILED DESCRIPTION OF THE INVENTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

In one or more embodiments, a door system having a door structure, core module and trim panel is provided. The core module includes a lock reinforcement member. The lock reinforcement member provides a rigid structure to support a lock mechanism. The reinforcement member also modifies and strengthens the door structure to which it is attached in the area of the lock. Accordingly, assembly of the core module to the door structure is simplified by allowing a pure Y-direction assembly of the core module and lock mechanism. Because of the lock reinforcement member, the lock mechanism can be assembled with the other components of the core module at the Tier 1, eliminating yet another component of the door system requiring costly assembly at the manufacturer. The term “Y-direction” as used herein refers to a direction perpendicular to the X-direction in the horizontal plane where the X-direction is the driving direction of the vehicle.

The lock reinforcement member can be fabricated from a separate component and assembled onto the core module. Preferably, the lock reinforcement member is insert-molded with the core module. The lock reinforcement member and the core module can be made from the same material or the same combination of materials. The reinforcement member and the core module can also be made from different materials or a different combination of materials. Preferably, the reinforcement member is injection molded in a two component process (“2K process”) with the core module. Suitable materials for the reinforcement member and core module are discussed in more detail below.

As used herein the term “door” is intended to include any door. For example, the term “door” can refer to one or more passenger doors, whether hinged, sliding, lifting or with any other alternative opening/closing movement, lift gates, tail gates, and hatchbacks for any vehicle including cars, trucks, SUVs, trains, boats, airplanes, etc., whether for personal, recreational or commercial use.

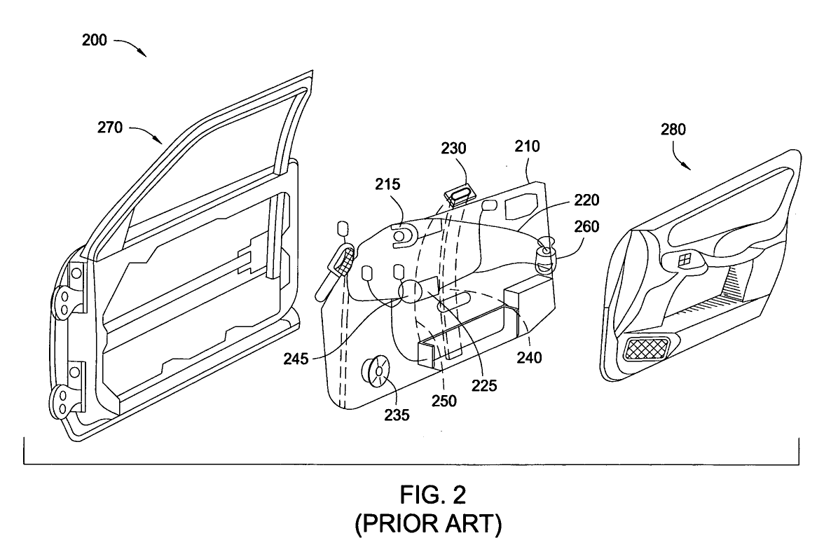

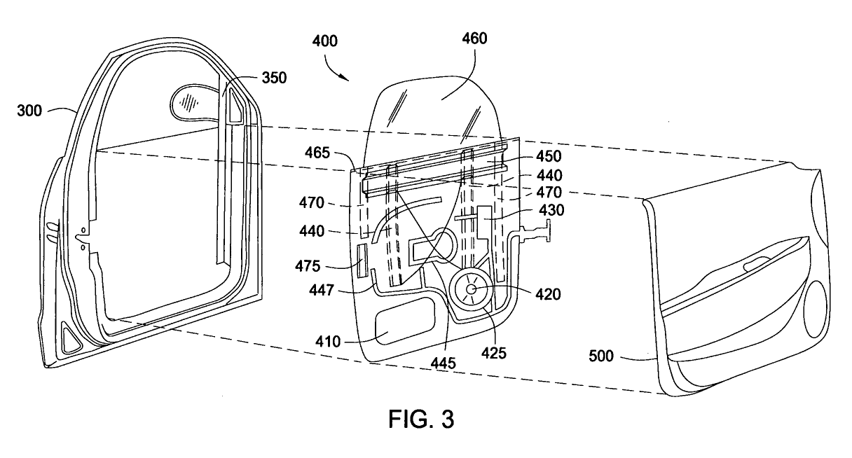

FIG. 3 shows a schematic view of an illustrative door system according to one or more embodiments. In at least one specific embodiment, the door system includes a door structure 300, core module 400, and trim panel 500. In one or more embodiments, the core module 400 is attached to the door structure 300 and the trim panel 500 is attached to either the core module 400 or the door structure 300 to complete the door system although any sequence can be used.

The core module 400 provides a body or substrate for one or more hardware components, electrical components and sealing components attached to or otherwise assembled thereon. Illustrative components assembled to the core module 400 include, but are not limited to window regulators; motors; tracks; impact bolsters; wire harnesses; speaker boxes or receptacles; speakers; window motors; outside mirror motors; beltline seals; plugs; grommets; and core to frame seals. For simplicity and ease of illustration, however, the core module 400 is shown in FIG. 3 having one or more bolsters or crash pads 410, speaker boxes 425, window tracks 440, motor supports 445, window glass 460, belt line seals 465, and glass run channels 470. It is to be understood that the core module 400 can include any other component typical of an automotive door. For example, the core module 400 can include one or more speakers 420, door control units 430, lock cables 447, and door locks (not shown in this view). The core module 400 can also include one or more air distribution channels for heating or air (not shown).

Preferably, the various components are injection molded on the core module 400. For example, the one or more bolsters 410, speaker boxes 425, window tracks 440, motor support 445, reinforcement member 450, belt line seal 465, glass run channels 470, and air distribution channels (not shown) can be integrally formed with the core module 400 using multi-material or multi-shot injection molding techniques.

Multi-material injection molding techniques allow two or more materials to be injection molded into a single or multiple cavity mold. A two component or material process is commonly known as “2K” and a three material process is commonly known as “3K.” Any suitable multi-material injection molding machine can be used, such as an Engel Victory Combi machine available from Engel Corp. Additional in-mold processing techniques can also be used to enhance and/or facilitate the integration. Illustrative in-mold processing techniques include, but are not limited to, multiple cavity tools, insert molding, movable core sections, and gas/water assist. Robotic extrusion can also be used alone or in combination with any of these processing techniques. Robotic extrusion is particularly useful for applying the sealing members into the injection mold.

The glass run channels 470 can be 2K molded on the second side of the core module 400 using a multi-material injection molding machine. The second material is preferably a flocked or slip coated to reduce friction with the window glass or the surface friction of the second material can be low enough to allow the glass to slide along it with acceptable force. Alternatively, the glass run channel 470 can be a separate member attached or otherwise assembled onto the core module 400.

Preferably, the glass run channels 470 are formed on the exterior side of the core module 400 and therefore shown in dashed lines in FIG. 3. The glass run channel 470 can have one or more profiles, such as “U” shaped, “L” shaped, or any combinations thereof, either alone in combination with one or more lips, bulbs, or other sealing elements. The glass run channel 470 preferably has a shaped profile or at least one lip to match the “L” shaped profile of the lower portion 350A (shown in FIG. 4) of the glass run channel 350 on the door structure 300. As such, when the core module 400 is attached to the door structure 300, the mating profiles of the glass run channels 350 and 470 provide a shaped guide for the window glass 460 to travel.

Still referring to FIG. 3, the one or more window tracks 440 are preferably located on the second side of the core module 400 with the glass run channels 470. As mentioned above, the one or more window tracks 440 can be integrated with the core module 400. Preferably, the window tracks 440 are injection molded on the core module 400. A slip coating (not shown in this view) can be inserted into the mold where the window tracks 440 are formed to reduce friction with the window glass. This can be done using the 2K or multi-material injection techniques or robotic extrusion. Alternatively, the slip coat can be inserted in the tool before the tracks 440 are molded. This can be done, for example, as a coating on a thin polymeric film. Alternatively, a thin polymeric film with a flock coating can be inserted into the tool and overmolded. The slip coating is preferably made of a material that can reduce friction between the window tracks 440 and the window glass. The slip coating can be made of polyethylene, polypropylene or other suitable materials, including the materials discussed herein. If the coefficient of friction of the base material from which the seal is made is low enough, it is no longer necessary to add a low friction surface to the seal.

In one or more embodiments, the core module 400 includes at least one reinforcement member (“first” reinforcement member) 450 disposed at an upper portion thereof. The reinforcement member 450 adds strength and stiffness to the core module 400 and the overall door system when assembled. The reinforcement member 450 can be disposed on either the interior side (“first side”) of the core module 400 or the exterior side (“second side”) of the core module 400. In FIG. 3, the reinforcement member 450 is shown on the interior side of the core module 400, opposite the window tracks 440. As used herein, the term “interior” refers to an orientation or direction facing toward the passenger compartment or inside of the vehicle, and the term “exterior” refers to an orientation or direction facing away from the passenger compartment or inside of the vehicle.

In one or more embodiments, the reinforcement member 450 is fabricated from a separate component and assembled onto the core module 400. For example, the reinforcement member 450 can be stamped from steel or aluminum, or fabricated from one or more non-metallic materials such as polypropylene or one or more engineering resins discussed below. In one or more embodiments, the reinforcement member 450 is insert-molded with the core module 400. For example, the reinforcement member 450 can be stamped from aluminum, steel, or other suitable metal or alloy, and inserted into the injection molding tool and at least partially over-molded with the core module 400 material. Preferably, the core module 400 and reinforcement member 450 are integrally formed (i.e., insert molded) to reduce the number of components requiring assembly.

In one or more embodiments, the core module 400 includes at least one reinforcement member (i.e., “lock” reinforcement member or “second” reinforcement member) 475 disposed on a perimeter of the core module 400. Similar to the first reinforcement member 450, the lock reinforcement member 475 can be stamped from steel or aluminum, or fabricated from one or more non-metallic materials such as polypropylene or one or more engineering resins discussed below. In one or more embodiments, the lock reinforcement member 475 is fabricated from a separate component and assembled onto the core module 400. In one or more embodiments, the lock reinforcement member 475 is insert-molded with the core module 400. For example, the lock reinforcement member 475 can be stamped from aluminum, steel, or other suitable metal or alloy, and inserted into the injection molding tool and at least partially over-molded with the core module 400 material.

The lock reinforcement member 475 is designed to support a lock mechanism (not shown in this view) to facilitate assembly of the core module 400 to the door structure 300. Any lock mechanism can be supported by the second reinforcement member 475. Illustrative lock mechanisms can include a housing, a latch mechanism, a mechanical or powered actuator, a controller unit, one or more antennae, one or more detectors (proximity, motion, etc.), connection points to the door and car for electronic, electrical, mechanical, optical, hydraulic, pneumatic or other systems available from a large number of suppliers to the automotive industry such as Kiekert AG.

To facilitate assembly of the core module 400 having a lock mechanism assembled thereon to the door structure 300, a portion of the door structure 300 is removed so that the lock mechanism can be moved into place with little manipulation. The lock reinforcement member 475 supports the lock mechanism for assembly purposes and reinforces that portion removed from the door structure 300. Accordingly, the lock reinforcement member 475 serves as a carrier or support for the lock mechanism and also serves as a structural support for the door structure 300. After or prior to assembling the core module 400 to the door structure 300, the lock mechanism can be secured or otherwise attached to the door structure 300.

Considering the door structure 300 in more detail, FIG. 4 shows a schematic plan view of one embodiment of an illustrative door structure 300. The door structure 300 has a first side or interior side 310 that faces the passenger compartment of the vehicle. The door structure 300 also has a second side or exterior side to which a side mirror 312 and external door handle (not shown in this view) can be attached.

The interior side 310 of the door structure 300 can include a recessed cavity 315 forming a shoulder 317 about a perimeter of the door structure 300. The cavity 315 is sized and shaped to resemble the dimensions of the core module 400 such that when assembled, at least a portion of the core module 400 fits into the recessed cavity 315 of the door structure 300.

The shoulder 317 has a certain depth or thickness to lend support to the door structure 300. At least a portion of the shoulder 317 is removed to form a notch 318. As mentioned above, the notch 318 is formed to facilitate assembly of the core module 400 to the door structure 300. In particular, the notch 318 eliminates a section of the shoulder 317 that would be an obstruction to a lock mechanism pre-assembled on the core module 400. The notch 318 receives a portion of the lock mechanism that protrudes beyond (i.e., in the X or Y-directions from) the core module 400. The notch 318 is situated to align with the lock reinforcement member 475 (shown in FIG. 3) on the core module 400. Assembly of the core module 400 to the door structure 300 is discussed in more detail below.

In one or more embodiments, the door structure 300 is fabricated from one or more separate panels. For example, the door structure 300 can include an outer skin 320 and an inner support 330 affixed to one another. In this embodiment, the outer skin 320 defines the shoulder 317, and the notch 318 is removed or cut from a portion of the outer skin 320.

Each of the outer skin 320 and the inner support 330 can be injection molded from polyethylene, polypropylene and more preferably from a reinforced polypropylene. In certain embodiments, each of the outer skin 320 and the inner support 330 can be injection molded, cast, extruded, molded or formed in any other way from one or more other suitable materials, including polyethylene, polypropylene, and/or any one or more materials described herein. In one or more embodiments, each of the outer skin 320 and the inner support 330, can be stamped from aluminum or cold, rolled steel, assembled, and painted to meet the specifications of the OEM. In one or more embodiments, each of the outer skin 320 and the inner support 330 can be made from different types of steel (i.e., “tailored blanks”), welded together stamped and painted as desired. Furthermore, the door structure 300 can be a single component or single panel.

Still referring to FIG. 4, the door structure 300 has an upper portion thereof that has an opening 340 for the window glass (not shown). Within the opening 340, the door structure 300 includes a seal or glass run channel 350 for mating engagement with the window glass when assembled. At least a portion of the glass run channel 350 extends into the cavity 315 of the door structure 300 as shown. In one embodiment, a first portion 350A of the glass run channel 350 is attached to the door structure 300 below the belt line 353 of the door structure 300, and a second portion 350B thereof is attached at a lower end of the door structure 300, as shown in FIG. 4. Preferably, at least one of the first and second portions 350A, 350B of the glass run channel 350 has enough length to contact the window glass when the window glass is in a lowered position. More preferably, both the first and second portions 350A, 350B of the glass run channel 350 have a sufficient length to contact the window glass when the window glass is in a lowered position.

The glass run channel 350 can be made from one or more separate sections or members that are fitted, welded, or otherwise attached together or kept in a fixed orientation relative to each other. Preferably, the glass run channel 350 is made from a single member. In one or more embodiments, the glass run channel 350 has one or more cross sections (i.e., profiles) adapted to contact the window glass. Illustrative profiles include “U” shaped, “L” shaped, and combinations thereof.

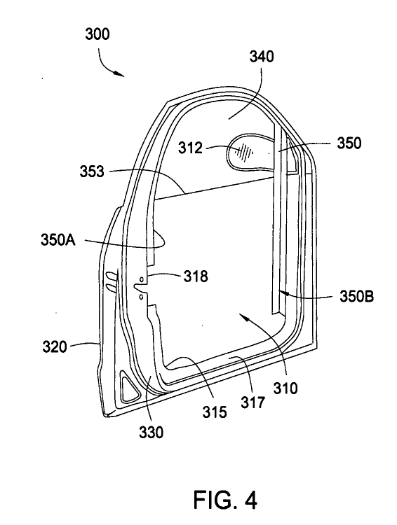

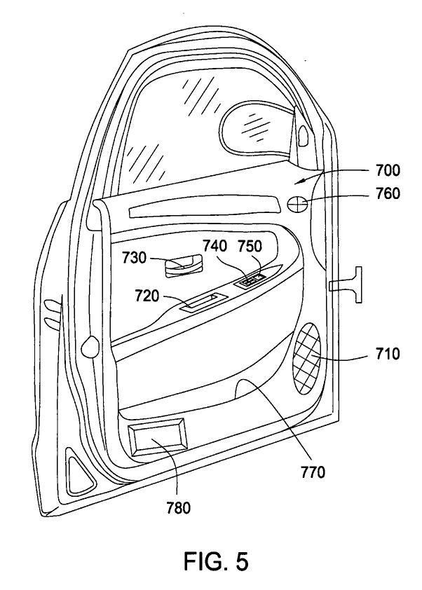

Considering the trim panel 700 in more detail, FIG. 5 shows a schematic plan view of an illustrative trim panel 700. The trim panel 700 provides a housing or substrate for one or more electrical, mechanical and sealing components to be attached or integrally molded, or insert molded thereto. Illustrative components include, but are not limited to air bags, air vents, switches; door handles; door locks; arm rests; map pockets; speaker covers or grilles; speakers; beltline seals; plugs; grommets; and core to frame seals. Illustrative switches can be used for window glass control, window locks, outside mirror positioning controls, door locks, seat positioning controls, and stereo controls. As shown in FIG. 5, the trim panel 700 can further include one or more speaker covers 710, arm rests 720, door handle 730, window switches 740, door lock switches 750, side mirror controls 760, map pockets 770, and interior lights 780.

Preferably, the trim panel 700 is injection molded from one or more materials, such as polypropylene or the one or more engineering resins. In one or more embodiments, the arm rest 720, speaker cover 710, and map pocket 770 are injection molded on the trim panel 700 using multi-material or multi-shot injection molding techniques.

In one or more embodiments above or elsewhere herein, any one or all of the door structure 300, core module 400, and trim panel 700 can include one or more seals, plugs, and/or grommets. Preferably, the one or more seals, plugs, and grommets are injection molded on the substrate or body (i.e., the door structure 300, core module 400, or trim panel 700). Preferably, any one or more of the seals, plugs, and grommets are directly molded on the door structure 300, core module 400, and/or trim panel 700 using two or three shot injection molding or robotic extrusion techniques. The integrated seals, plugs, and grommets help prevent or eliminate water seepage, rattles and vibration. Such components also increase the acoustical performance of the part (i.e., provide sound insulation and the “closing sound” of the door) while compensating for differences in part tolerance and expansion while allowing some movement.

### Assembly Sequence

Referring again to FIG. 3, the door system can be easily assembled. In general, the one or more components are inserted into an injection mold for making the core module 400. The core module 400 and the inserted components are injection molded with a first material. A second material, such as a thermoplastic vulcanizate (TPV), can be injection molded to create the flexible components (seals, plugs, grommets, or soft touch portions of the skin) on the core module 400. Gas or water assist can also be used to create hollow profiles where needed for additional structure strength. Foaming agents can be used to create foam structures to minimize sink marks or to create a foam structure for increased stiffness. The core module 400 having the integrated components formed thereon is ejected from the tool. A lock mechanism and any other parts of the door that have not yet been integrated to the core module 400 are then assembled. The window glass 535 (shown in FIG. 4) is assembled to the core module 400 last and properly adjusted. The core module 400 is then ready for delivery to the assembly line.

At the assembly line, the core module 400 is attached to the door structure 300, and the trim panel 700 is attached to the door assembly and all connections between the core and the door structure (mechanical, electrical, or other). Alternatively, the trim panel 700 can be attached to the core module 400 which is then attached to the door structure 300. The door assembly is then ready to be assembled to the vehicle.

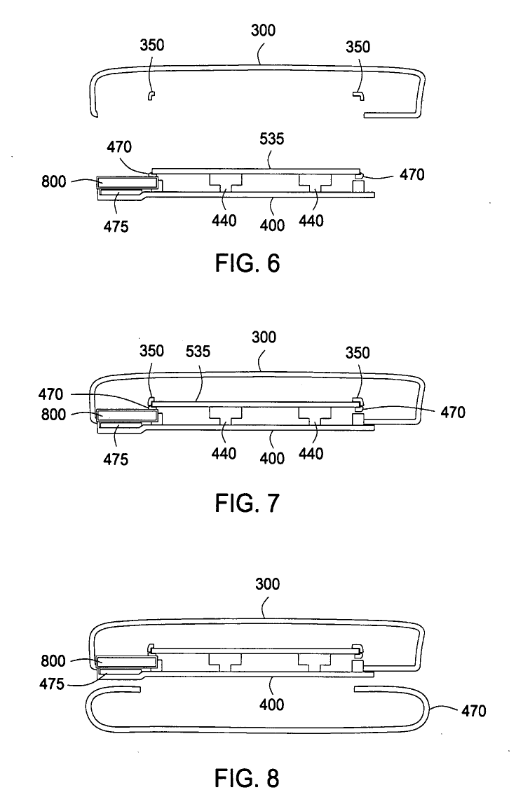

FIGS. 6-8 show a simplified, schematic illustration of one particular sequence for assembling the door assembly. Referring to FIGS. 6-8, the core module 400 includes one or more window tracks 440 (two are shown), glass run channel 470, lock reinforcement member 475, lock system 800 and window glass 535. The window glass 535 is shown in contact or communication with the one or more window tracks 440 and the glass run channel 470. The lock mechanism 800 is secured or otherwise assembled on the lock reinforcement member 475. The assembled core module 400 is moved toward the door structure 300 until the window glass 535 contacts the half U-shaped profiles 350 on the door structure 300, as shown in FIG. 7. Due to absence of a portion of the perimeter of the door structure 300 (i.e., the notch 318 shown in FIG. 4), the core module 400 is easily aligned and brought into contact with the door structure 300. The core module 400 can then be secured to the door structure 300. During or after the assembly of the core module 400 onto the door structure 300, the reinforcement member 475 can also be attached to the door structure 300. Preferably, the fastening member connects both the core module 400 and the reinforcement member 475 to the door structure 300. Alternately, if there is more than one fastening member, then each fastening member connects both the core module 400 and the reinforcement member 475 to the door structure 300. With this the lock system 800 is also fixed. If required, the lock system 800 can be separately attached to the door structure 300, preferably by a fastening member in the X-direction located next to the opening for the latch in the door structure 300. This additional connection can be made before, during or after the assembly of the core module 400 onto the door structure 300. Suitable fastening members can include one or more screws, bolts, rivets, clips, etc. Finally, any mechanical and/or electrical connections can be made if they have not already been made. The trim panel 700 is then attached to the door structure 300 using one or more screws, bolts, rivets, clips, or other fastening members (not shown) to complete the assembly as shown in FIG. 8.

### Belt-Line Reinforcement Configurations

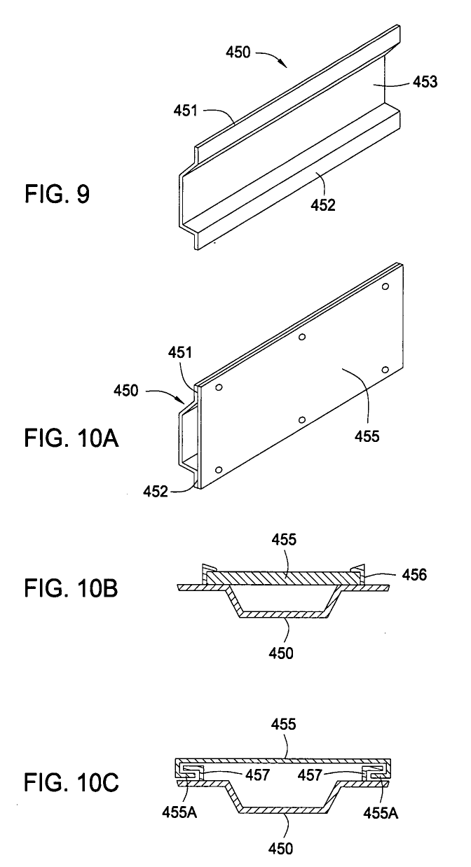

Considering the reinforcement member 450 and the lock reinforcement member 475 in more detail, FIGS. 9-12C show various configurations of reinforcement members that can be used. The lock reinforcement member 475 can be similar or identically designed as the reinforcement member 450. The difference being the lock reinforcement member 475 is smaller and vertically aligned with relation to the core module 400 whereas the reinforcement member 450 is longer and disposed horizontally on the core module 400. For simplicity and ease of illustration, the following discussion is with reference to the larger, horizontally arranged reinforcement member 450, but one can easily determine how to vertically align and scale down the reinforcement member 450 to serve as the lock reinforcement member 475. The size and shape of either reinforcement member 450, 475 are immaterial, and are a matter of design and preference.

FIG. 9 is a schematic view of an illustrative reinforcement member 450, 475 in accordance with one or more embodiments described. Referring to FIG. 9, the reinforcement member 450, 475 can include a top flange 451 and a bottom flange 452 for assembly to the core module 400 (not shown in this view). Also not shown in this view, each flange 451, 452 can include one or more apertures to receive one or more fastening member, such as a clip, screw, bolt, rivet, etc. In one or more embodiments, the reinforcement member 450, 475 can include a recessed section 453 located between the flanges 451, 452, as shown in FIG. 9. The recessed section 453 can have any depth whether constant or variable. The depth helps provide stiffness (i.e., resistance against deformation).

In one or more embodiments above or elsewhere herein, the reinforcement member 450, 475 can include a cover plate 455 disposed thereon to provide added strength and stiffness, as shown in FIG. 10A. FIG. 10A shows a schematic plan view of the reinforcement member 450, 475 having the cover plate 455 attached thereto. The cover plate 455 is preferably secured to the reinforcement member 450, 475 at the top and bottom flanges 451, 452. The cover plate 455 can be attached to the reinforcement member 450, 475 using adhesion or any mechanical fastener including, for example, screws, bolts, rivets, clips, etc. The cover plate 455 can also be spot welded to the reinforcement member 450, 475.

In one or more embodiments above or elsewhere herein, the cover plate 455 can be attached to the reinforcement member 450, 475 using one or more clips 456 as shown in FIG. 10B. FIG. 10B shows a schematic cross sectional view of the reinforcement member 450, 475 with one or more clips 456 to hold the cover plate 455 thereon. Preferably, the one or more clips 456 are injection molded or integrally formed with the reinforcement member 450, 475 although the one or more clips 456 can be easily attached during assembly.

In one or more embodiments above or elsewhere herein, the cover plate 455 can slide onto the reinforcement member 450, 475. For example, the cover plate 455 can include a profiled edge adapted to slide across a mating profiled edge of the reinforcement member 450, 475, as shown in FIG. 10C. FIG. 10C shows a partial cross section of the reinforcement member 450, 475 and cover plate 455 having profiled edges adapted to engage and slide thereabout. The profiled protrusion 457 of the reinforcement member 450, 475 engages the profiled edge 455A of the cover plate 455, serving as a rail or guide for which the cover plate 455 can slide. Preferably, the clearance between the profiled edge 455A of the cover plate 455 and the profiled protrusion 457 of the reinforcement member 450, 475 is just enough for the cover plate 455 to slide into place and held in place without later vibrating or rattling during use.

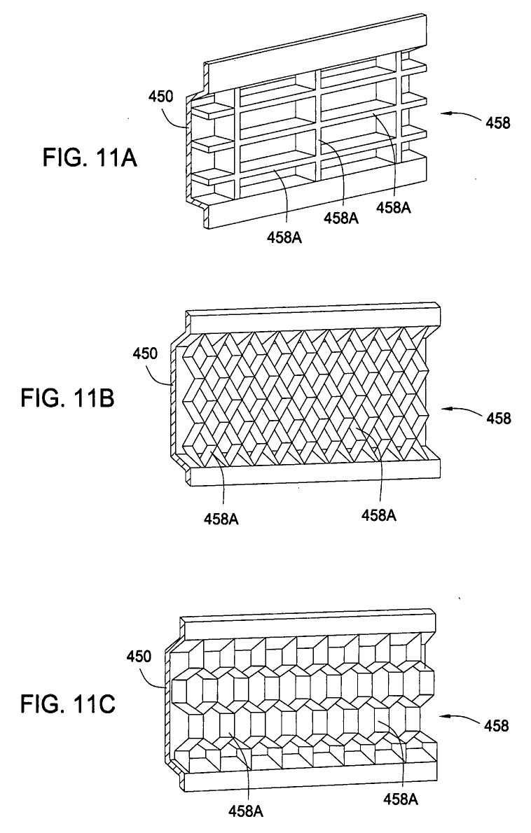

In one or more embodiments above or elsewhere herein, the reinforcement member 450, 475 can include an insert or stiffening structure 458 (as shown in FIG. 11A) disposed within the recessed section 453 (not shown). FIG. 11A is a schematic view of an illustrative reinforcement member 450, 475 having one or more inserts 458. Preferably, the insert 458 includes one or more fingers or ribs 458A that can be formed by over-molding a plastic structure within the recessed section 453 of the reinforcement member 450, 475. The insert 458 increases resistance against deformation. The insert 458 can provide significantly higher energy absorption and resistance against buckling. After over-molding the insert 458, the cover plate 455 can be disposed thereon as explained above with reference to FIGS. 10A-C, to provide additional strength.

In one or more embodiments above or elsewhere herein, the ribs 458A of the insert 458 can be arranged in various patterns as shown in FIGS. 10A-10C. For example, the ribs 458A can have a rectangular pattern to resemble a checker board as shown in FIG. 11A. In one or more embodiments, the ribs 458A can have a diamond-shaped pattern as shown in FIG. 11B. In one or more embodiments, the ribs 458A can have a honeycomb or polygonal pattern as shown in FIG. 11C. Other patterns include tubulars and circles. The desired pattern can depend on the stiffness and strength needed for the application and design considerations.

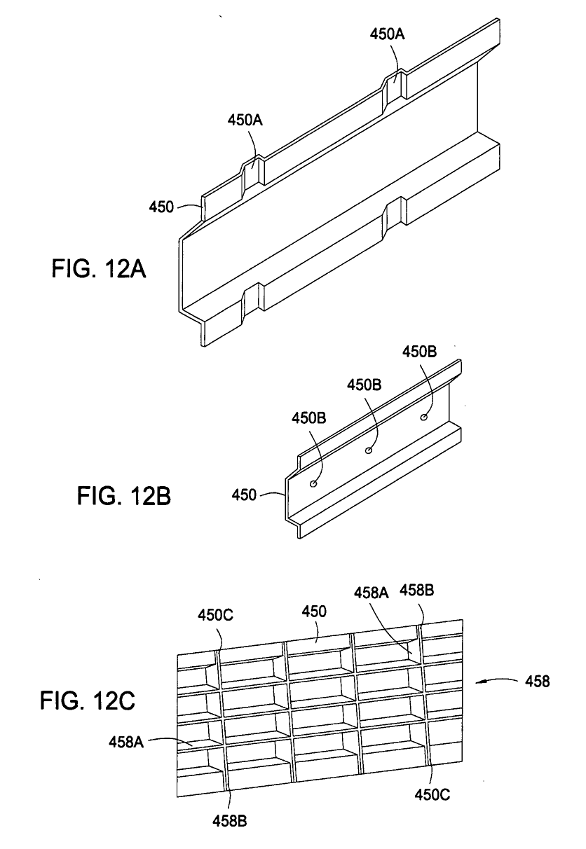

FIGS. 12A, 12B, and 12C each show schematic plan views of an illustrative reinforcement member 450, 475 having an insert disposed therein. Referring to FIGS. 12A-12C the insert 458 can be disposed within or otherwise attached to the recessed section 453 of the reinforcement member 450, 475 using a variety of techniques. FIGS. 12A-12C each show illustrative plan views of a reinforcement member 450, 475 having various ways to hold the insert 458. For example, the reinforcement member 450, 475 can include one or more recesses or depressions 450A to provide a location or anchor for at least a portion of the insert 458, as shown in FIG. 12A. Accordingly, the insert 458 can include a mating protrusion (not shown) to fit within the depressions 450A of the reinforcement member 450, 475, and contact the main body of the core module 400. As such, the insert 458 can be held in place during assembly. If the optional cover plate 455 is used, the insert 458 can be held in place with the depressions 450A until the cover plate 455 is secured into place.

In one or more embodiments above or elsewhere herein, one or more apertures 450B can be formed within the recessed section 453 of the reinforcement member 450, 475, as shown in FIG. 12B. During the over-molding injection process the apertures 450B allow the material of the insert 458 to flow through the reinforcement member 450, 475. As such, the material of the insert 458 is anchored within the reinforcement member 450, 475 and secured in place.

In one or more embodiments above or elsewhere herein, the reinforcement member 450, 475 can include one or more slits or openings 450C to receive a protruding feature 458B of the insert 458, as shown in FIG. 12C. The protruding feature 458B of the insert 458 can simply be an extension of one or more ribs 458A. The one or more slits 450C of the reinforcement member 450, 475 can be biased or otherwise designed to provide a friction fit to hold the insert 458 in place.

In any of the embodiments described above with reference to FIGS. 12A-12C, the insert 458 can be held into place on the reinforcement member 450 and be ready for use. Alternatively, the insert 458 can be held into place on the reinforcement member 450 for such length of time to allow a bonding adhesive of the cover plate 455 to reach sufficient strength, thereby relying on the cover plate 455 to hold the insert 458 in place during use. Further, the embodiments described allow the insert 458 to be held into place on the reinforcement member 450 for such length of time to allow the cover plate 455 to be mechanically fastened to the reinforcement member 450, 475 or the core module 400. Suitable mechanical fasteners include clip screws, heat stakes, rivets, blind rivets, and bolts, just to name a few. Spot welding can also be used.

In any of the embodiments above or elsewhere herein, hollow sections in the reinforcement member 450 can be completely or partially filled with foam. This foam can be pre-foamed and shaped to fit in the desired hollow section and positioned. Assembly of the foam can be done by means of mechanical friction or mechanical undercut, adhesion system, mechanical fastener system, hot welding or other systems. The foam can also be foamed in place and attached to the reinforcement member 450 by mechanical locking or by direct adhesion to the reinforcement member 450.

### Materials

The components described, including the door structure 300, glass run channels 350 and 470, core module 400, belt-line reinforcement member 450, lock reinforcement member 475, and trim panel 700, can be made from any material having the requisite properties, such as stiffness and strength for example. Suitable materials include, but are not limited to, propylene homopolymers, propylene copolymers, ethylene homopolymers, ethylene copolymers, and or any one or more of the following polymer resins:
a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, nylon 66/PPS copolymer;
b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters;
c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS);
d) polymethacrylate resins such as polymethyl methacrylate and polyethylacrylate;
e) cellulose resins such as cellulose acetate and cellulose acetate butyrate;
f) fluorine resins such as polyvinylidene fluoride (PVDF), polyvinyl fluoride (PVF), polychlorofluoroethylene (PCTFE), and tetrafluoroethylene/ethylene copolymer (ETFE);
g) polyimide resins such as aromatic polyimides;
h) polysulfones;
i) polyacetals;
j) polyactones;
k) polyphenylene oxides and polyphenylene sulfides;
l) styrene-maleic anhydrides;
m) aromatic polyketones,
n) polycarbonates (PC);
o) elastomers such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like); and
p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, sand, glass beads, mineral aggregates, talc, and hydrotalcite compounds of the ions Mg, Ca, or Zn with Al, Cr, or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g., Kevlar or Twaron), meta-aramide fibers (e.g., Nomex), polyethylene fibers (e.g., Dyneema), and combinations thereof.

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Most preferred is a PP reinforced with a PET fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D-4703 Method B or ASTM D-1505, and a melt index (MI) between 0.10 dg/min and 30 dg/min according to ASTM D-1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D-1238. Preferred plastomers can have an average molecular weight of from 10,000 to 800,000 in one embodiment, and from 20,000 to 700,000 in another embodiment. The molecular weight distribution (Mw/Mn) of desirable plastomers ranges from 1.5 to 5 in one embodiment, and from 2.0 to 4 in another embodiment. The 1% secant flexural modulus (ASTM D-790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. Preferably, the copolymer has a density less than 0.915 g/cm³. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MPa. Further, preferred blends will have a flexural modulus of 1,750 MPa or more, such as about 1,800 MPa or more, or more than about 2,000 MPa.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

As noted above, the degree of integration described can dramatically reduce the cost and assembly complexity of the finished door. Logistical costs, for example, are also significantly reduced, which reduces the amount of assembly errors in addition to the overall cost. Functional testing costs after final assembly are also reduced or eliminated because a majority of the functionality can be tested prior to final assembly (i.e., pre-tested). Further, the use of plastic materials in the door assembly can provide lower overall weight, more part integration, improved noise insulation, greater design freedom and will enable cheaper design modifications (i.e., using replaceable inserts in an injection molding tool).

The multi-material injection molding techniques described can also provide a unique combination of materials. Further, the number of secondary attachment techniques needed for multiple components such as rivets, screws, adhesives, clips, snaps, etc., is greatly reduced, if not eliminated all together in some instances.

In another embodiment, this invention relates to:

1. A core module, comprising:
a body;
a first reinforcement member disposed at an upper portion of the body;
a second reinforcement member disposed on a perimeter of the body; and
a lock mechanism attached to the second reinforcement member.

2. The core module of paragraph 1, wherein at least one of the first reinforcement member, the second reinforcement, and the lock mechanism are integrally formed on the body.

3. The core module of paragraph 1 or 2, wherein at least one of the reinforcement members comprises a first flange and a second flange, each adapted to contact the body.

4. The core module of paragraph 1, 2, or 3, wherein at least one of the reinforcement members comprises a first flange, a second flange and a recessed portion between the flanges.

5. The core module of paragraph 4, wherein the reinforcement member further comprises an insert disposed therein, the insert comprising one or more stiffening members.

6. The core module of paragraph 5, wherein the reinforcement member further comprises a cover plate disposed thereon to define a hollow cavity between the first reinforcement member and the cover plate.

7. The core module of any of paragraphs 1 to 6, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

8. The core module of any of paragraphs 1 to 7, wherein the body further includes one or more components selected from the group consisting of a window regulator, window track, impact bolster, air channel, window motor housing, map pocket, speaker box, plug, grommet, and combinations thereof.

9. The core module of any of paragraphs 1 to 8, wherein the body is injection molded from polypropylene.

10. The core module of any of paragraphs 1 to 9, wherein the body is injection molded from one or more engineering resins.

11. The core module of any of paragraphs 1 to 10, wherein the body is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

12. The core module of any of paragraphs 1 to 11, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

13. A door system, comprising:
an outer panel having a notch formed in an outer wall thereof;
a core module comprising:
a body;
a first reinforcement member disposed at an upper portion of the body;
a second reinforcement member disposed on a perimeter of the body, the second reinforcement member adapted to at least partially cover the notch formed in the outer panel; and
a lock mechanism attached to the second reinforcement member; and
a trim panel adapted to at least partially cover the core module.

14. The door system of paragraph 13, wherein at least one of the first and second reinforcement members comprise a first flange and a second flange, each adapted to contact the first side of the body.

15. The door system of paragraph 13 or 14, wherein at least one of the first and second reinforcement members comprises a first flange, a second flange and a recessed portion between the flanges.

16. The door system of paragraph 13, 14, or 15, wherein the reinforcement member further comprises an insert disposed therein, the insert comprising one or more stiffening members.

17. The door system of any of paragraphs 13 to 16, wherein the reinforcement member further comprises a cover plate disposed thereon to define a hollow cavity between the reinforcement member and the cover plate.

18. The door system of any of paragraphs 13 to 17, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

19. The door system of any of paragraphs 13 to 18, wherein the one or more components are integrally formed on the body.

20. The door system of paragraph 19, wherein the one or more components comprise a window regulator, window track, impact bolster, air channel, window motor housing, map pocket, speaker box, plug, grommet, or combinations thereof.

21. The door system of any of paragraphs 13 to 20, wherein the body comprises polypropylene.

22. The door system of any of paragraphs 13 to 21, wherein the body is injection molded from polypropylene.

23. The door system of any of paragraphs 13 to 22, wherein the body comprises one or more engineering resins.

24. The door system of any of paragraphs 13 to 23, wherein the body is injection molded from one or more engineering resins.

25. The door system of any of paragraphs 13 to 24, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

26. The door system of any of paragraphs 13 to 25, wherein the body is injection molded from one or more engineering resins selected from the group consisting polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

27. The door system of any of paragraphs 13 to 26, wherein the outer panel comprises a glass run channel at least partially disposed thereon, the glass run channel having at least one portion having a closed profile and at least one portion having an opened profile.

28. The door system of paragraph 27, wherein the closed profile is U shaped.

29. The door system of paragraph 27 or 28, wherein the opened profile is L shaped.

30. The door system of paragraph 27, 28, or 29, wherein the opened profile and the glass run channel on the core module are adapted to form a closed profile when engaged with one another.

31. The door system of paragraph 27 or 28, wherein the at least one portion having the closed profile is located within a window surround of the outer panel.

32. The door system of paragraph 27 or 28, wherein the glass run channel is a single component having a first portion thereof with a U shaped profile and a second portion thereof with a L shaped profile.

33. A method for assembling a door system, comprising:
providing at least one outer panel, at least one core module, and at least one trim panel, the at least one outer panel having a notch formed in an outer wall thereof;
disposing a first reinforcement member on an upper portion of the core module;
disposing a second reinforcement member on a perimeter of the core module;
disposing a lock mechanism on the second reinforcement member;
disposing a first glass run channel on an exterior side of the core module;
disposing a second glass run channel on the outer panel;
disposing a window glass on the core module;
disposing the core module on the outer panel; and then
disposing the trim panel.

34. The method of paragraph 33, further comprising securing the lock mechanism to the outer panel.

35. The method of paragraph 34, further comprising attaching the core module to the outer panel.

36. The method of paragraph 33, 34 or 35 further comprising covering the notch in the outer panel with the second reinforcement member and securing the second reinforcement member to the outer panel.

One of ordinary skill in the art will recognize that the door system described can be utilized as a complete system, or the individual components thereof can be utilized separately as individual mini-systems or modular type units to help consolidate two or more components if desired.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents, including priority documents, cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A core module, comprising:
a body;
a first reinforcement member disposed at an upper portion of the body;
a second reinforcement member disposed on a perimeter of the body; and
a lock mechanism attached to the second reinforcement member.

2. The core module of claim 1, wherein at least one of the first reinforcement member, the second reinforcement, and the lock mechanism are integrally formed on the body.

3. The core module of claim 1, wherein at least one of the reinforcement members comprises a first flange and a second flange, each adapted to contact the body.

4. The core module of claim 1, wherein at least one of the reinforcement members comprises a first flange, a second flange and a recessed portion between the flanges.

5. The core module of claim 4, wherein the reinforcement member further comprises an insert disposed therein, the insert comprising one or more stiffening members.

6. The core module of claim 5, wherein the reinforcement member further comprises a cover plate disposed thereon to define a hollow cavity between the first reinforcement member and the cover plate.

7. The core module of claim 1, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

8. The core module of claim 1, wherein the body further includes one or more components selected from the group consisting of a window regulator, window track, impact bolster, air channel, window motor housing, map pocket, speaker box, plug, grommet, and combinations thereof.

9. The core module of claim 1, wherein the body is injection molded from polypropylene.

10. The core module of claim 1, wherein the body is injection molded from one or more engineering resins.

11. The core module of claim 1, wherein the body is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

12. The core module of claim 1, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

13. A door system, comprising:
an outer panel having a notch formed in an outer wall thereof;
a core module comprising:
a body;
a first reinforcement member disposed at an upper portion of the body;
a second reinforcement member disposed on a perimeter of the body, the second reinforcement member adapted to at least partially cover the notch formed in the outer panel; and
a lock mechanism attached to the second reinforcement member; and
a trim panel adapted to at least partially cover the core module.

14. The door system of claim 13, wherein at least one of the first and second reinforcement members comprise a first flange and a second flange, each adapted to contact the first side of the body.

15. The door system of claim 13, wherein at least one of the first and second reinforcement members comprises a first flange, a second flange and a recessed portion between the flanges.

16. The door system of claim 15, wherein the reinforcement member further comprises an insert disposed therein, the insert comprising one or more stiffening members.

17. The door system of claim 16, wherein the reinforcement member further comprises a cover plate disposed thereon to define a hollow cavity between the reinforcement member and the cover plate.

18. The door system of claim 13, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

19. The door system of claim 13, wherein the one or more components are integrally formed on the body.

20. The door system of claim 19, wherein the one or more components comprise a window regulator, window track, impact bolster, air channel, window motor housing, map pocket, speaker box, plug, grommet, or combinations thereof.

21. The door system of claim 13, wherein the body comprises polypropylene.

22. The door system of claim 13, wherein the body is injection molded from polypropylene.

23. The door system of claim 13, wherein the body comprises one or more engineering resins.

24. The door system of claim 13, wherein the body is injection molded from one or more engineering resins.

25. The door system of claim 13, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

26. The door system of claim 13, wherein the body is injection molded from one or more engineering resins selected from the group consisting polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

27. The door system of claim 13, wherein the outer panel comprises a glass run channel at least partially disposed thereon, the glass run channel having at least one portion having a closed profile and at least one portion having an opened profile.

28. The door system of claim 27, wherein the closed profile is U shaped.

29. The door system of claim 27, wherein the opened profile is L shaped.

30. The door system of claim 27, wherein the opened profile and the glass run channel on the core module are adapted to form a closed profile when engaged with one another.

31. The door system of claim 27, wherein the at least one portion having the closed profile is located within a window surround of the outer panel.

32. The door system of claim 27, wherein the glass run channel is a single component having a first portion thereof with a U shaped profile and a second portion thereof with a L shaped profile.

33. A method for assembling a door system, comprising:
providing at least one outer panel, at least one core module, and at least one trim panel, the at least one outer panel having a notch formed in an outer wall thereof;
disposing a first reinforcement member on an upper portion of the core module;
disposing a second reinforcement member on a perimeter of the core module;
disposing a lock mechanism on the second reinforcement member;
disposing a first glass run channel on an exterior side of the core module;
disposing a second glass run channel on the outer panel;
disposing a window glass on the core module;
disposing the core module on the outer panel; and then
disposing the trim panel.

34. The method of claim 33, further comprising securing the lock mechanism to the outer panel.

35. The method of claim 34, further comprising attaching the core module to the outer panel.

36. The method of claim 35, further comprising covering the notch in the outer panel with the second reinforcement member and securing the second reinforcement member to the outer panel.
